(19) United States
(12) Patent Application Publication
(10) Pub. No.: US 2012/0273544 A1
(43) Pub. Date: Nov. 1, 2012

(54) DRIVING MODULE FOR DRIVING FIXING MEANS

(75) Inventor: Gerhard Kuchler, Hamburg (DE)

(73) Assignee: ILLINOIS TOOL WORKS INC., Glenview, IL (US)

(21) Appl. No.: 13/513,232

(22) PCT Filed: Dec. 23, 2010
(86) PCT No.: PCT/US2010/062063

§ 371 Date: Jul. 17, 2012

(30) Foreign Application Priority Data
Dec. 28, 2009 (DE) 20 2009 017 659.2

(51) Int. Cl. B25C 1/04; B25C 1/00

(52) U.S. Cl. 227/130; 227/129

(57) ABSTRACT

A driving module for driving magazined fixing elements into workpieces includes an assembly support for a driving assembly. The driving assembly has a driver drive which acts with a driving force via a driver punch on the fixing element to be driven in each case. The driving assembly can be pressed onto the respective workpiece by a drive wedge, which extends in a wedge plane and acts on the driving assembly in order to press the driving assembly onto the respective workpiece. The driving assembly has a driver plane which is oriented parallel to the wedge plane and in which the line of force action of the driving force extends. The wedge plane is offset from the driver plane by an offset distance.

The present invention relates to a driving module for driving in particular magazined fixing means into workpieces, according to the preamble of claim 1.

The driving modules in question are principally used in the industrial manufacture of components in the prefabricated construction sector. The requirement exists there, for example in the dry construction sector, for plasterboard to be fixed to wooden frames or the like with fixing means, regularly with nails. The driving module in question is for this purpose arranged on a portal displacement unit and can be positioned in a correspondingly automated manner.

The known driving module (FI 884446 A1), on which the invention is based, is provided with an assembly support on which a driving assembly is arranged in a displaceable manner. The driving assembly is provided with a driver drive which has a pneumatic piston drive. The piston drive is used to drive the fixing means via a driver punch that can be displaced in the driving direction. Configuring the driver drive as a piston drive enables comparatively slow pushing of the fixing means into the workpiece, given a suitable design of the piston surface. Compared with the usual “shooting” of fixing means, this is associated above all with the production of little noise and with the possibility of setting a precise push-in depth.

In order to ensure secure positioning of the workpiece during the relatively slow pushing in of the fixing means, provision is made in the known driving module for the driving assembly as such to be pressed onto the workpiece. Provision is made for this purpose of a pressing drive, which acts with a drive wedge on the top side of the driving assembly. The drive wedge is in this case oriented in a centered manner on the piston drive such that the line of force action of the force of the pressing drive acting on the driving assembly lies in the same plane as the line of force action of the driving force, and so undesired tilting moments acting on the driving assembly are largely avoided.

A disadvantage with the known driving module is the not very compact construction. Against the background that the portal displacement units mentioned above are nowadays fitted with an ever greater number of modules, this leads increasingly to problems.

The invention is based on the object of configuring and developing the known driving module such that its compactness is increased.

The above object is achieved in the case of a driving module according to the preamble of claim 1 by the features of the characterizing part of claim 1.

What is essential is the finding that departing from the central orientation discussed above of the drive wedge can lead to a considerable increase in the compactness of the driving module.

It is firstly assumed in this case that the drive wedge of the pressing drive extends in a wedge plane. The wedge plane is defined here as that plane in which, with ideal observation (without taking into account any undesired deformations or the like), the forces acting on the wedge are located.

Further, the driving assembly is assigned a driver plane which is oriented parallel to the wedge plane and in which—likewise with ideal observation—the line of force action of the driving force extends.

It is now proposed that the pressing drive is configured and arranged such that the wedge plane is located in a manner offset by an offset distance from the driver plane. Although this leads to tilting moments acting on the assembly guide during pressing and driving, when the assembly guide is designed in a suitable manner, these tilting moments can be accepted in favor of the resulting installation space advantages described below.

What is essential is namely that in the solution as proposed, the driver plane can be readily realized in a manner free of the pressing drive, in particular of the drive wedge. Accordingly, other components can be arranged there.

In the preferred configuration according to claim 2, by way of example, the arrangement of the assembly guide is provided in the driver plane. Thus, the depth of the installation module perpendicularly to the driver plane can be kept small by simple means.

In the preferred configurations according to claims 3 to 5, the driver drive is configured in a preferred configuration as a pneumatic piston drive having a driver cylinder and a driver piston, wherein the inner surface of the driver cylinder is configured with a cross section that is elongate, in particular elliptical. The depth of the driving module can be reduced further as a result.

The removal, as proposed, of the pressing drive from the driver plane also has, according to claims 10 and 11, installation space advantages with regard to the arrangement of a magazining device for the fixing means. The essential components of the magazining device can preferably be arranged namely such that they extend in the driver plane. This is also appropriate, since the fixing means can thus be supplied to the driver punch directly without any deflection.

The invention is explained in more detail below with reference to an exemplary embodiment illustrated in the drawing, in which:

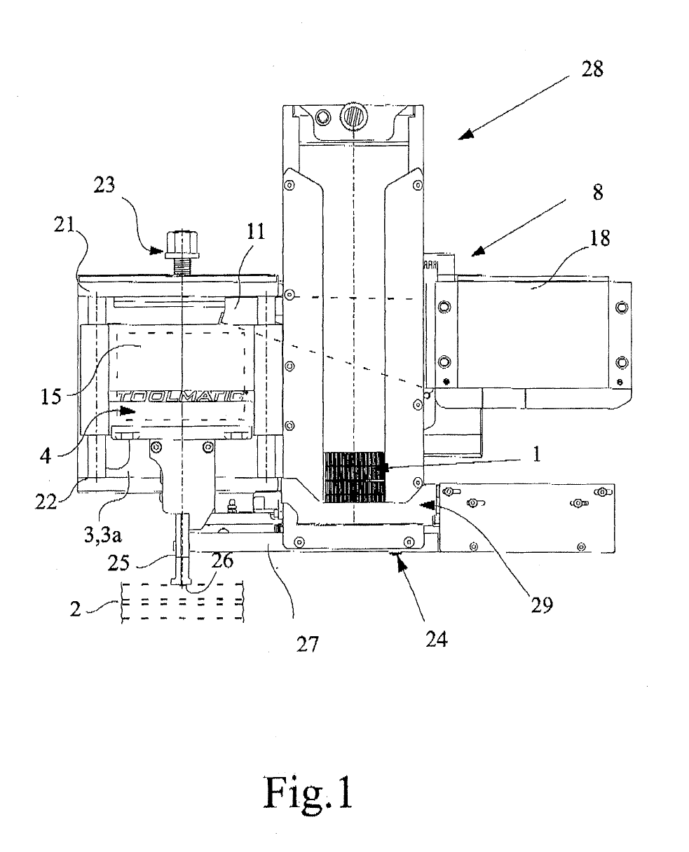

FIG. 1 shows a front view of a driving module as proposed,

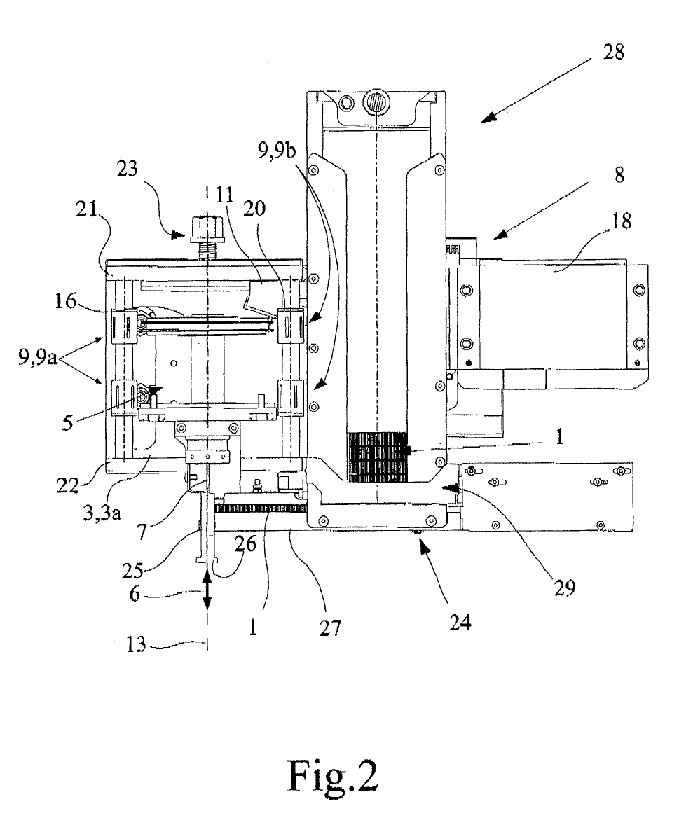

FIG. 2 shows a front view of the driving module according to FIG. 1 without a driving assembly front wall,

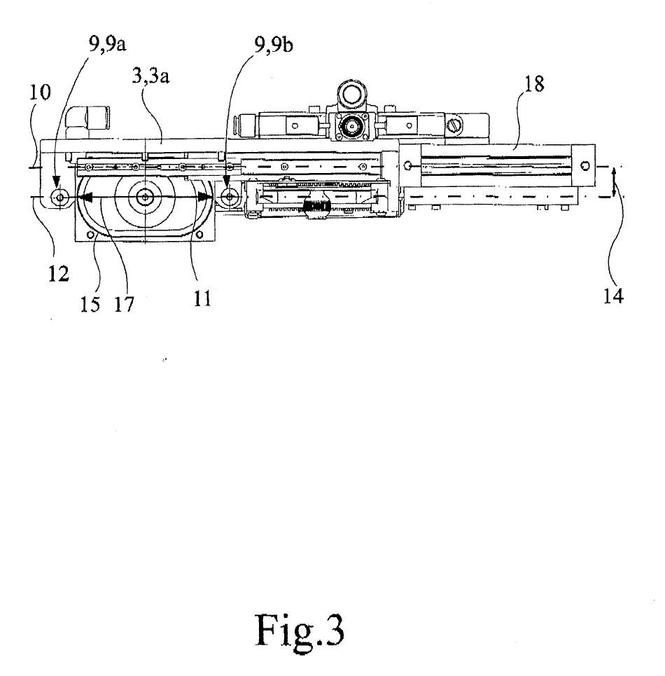

FIG. 3 shows a top view of the driving module according to FIG. 1 without a driving assembly top wall and with the upper guide support for the assembly guide demounted,

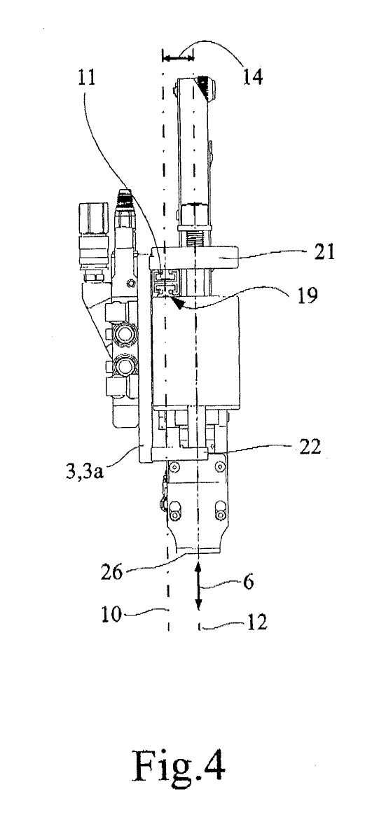

FIG. 4 shows a side view of the driving module according to FIG. 1 (from the left in FIG. 1),

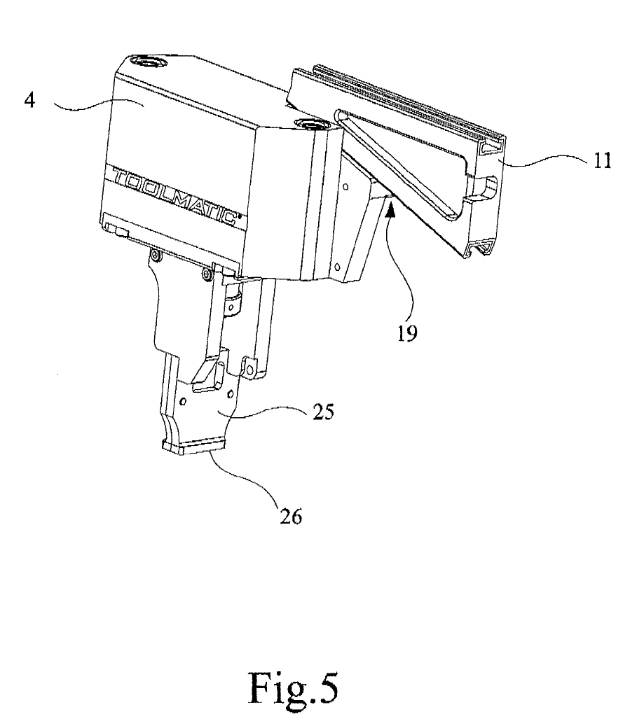

FIG. 5 shows the driving assembly according to FIG. 1 interacting with the drive wedge, with all the other components of the driving module according to FIG. 1 left out.

The driving module illustrated in FIG. 1 is suitable for driving any possible magazined fixing means 1 into workpieces 2. Preferably, the fixing means 1 are screws, pins or nails, in particular corrugated nails. The fixing means are manufactured regularly in strips, with the longitudinal extent of the strips being perpendicular to the respective driving direction.

The fundamental construction of the driving module as proposed can be gathered from viewing FIGS. 1 to 5 together. The driving module is provided with an assembly support 3 for a driving assembly 4. The driving assembly 4 has a driver drive 5, which acts with a driving force via a driver punch 7, which is displaceable in the driving direction 6, on the fixing means 1 to be driven in each case. In the narrower sense, the driving assembly 4 thus ensures that the fixing means 1 are driven into the workpiece 2. For driving, the driver punch 7 comes into engagement with the respective fixing means 1. Account should be taken in this case of the fact that the driving force during driving can vary depending on the design of the driver drive 5.

In order to prevent the workpiece 2 shifting position during driving, it is provided that the driving assembly 4 as such can be pressed onto the workpiece 2 by means of a pressing drive 8. For this purpose, the driving assembly 4 is guided displaceably in the driving direction 6 via an assembly guide 9 on the assembly support 3.

Of particular significance here is the configuration of the pressing drive 8 which has a drive wedge 11 that extends in a wedge plane 10 and acts on the driving assembly 4 in order to press the driving assembly 4. The interaction of the drive wedge 11 with the driving assembly 4 can be gathered best from viewing FIGS. 1 and 5 together, wherein the drive wedge 11 is illustrated partly by dashed lines in FIG. 1.

The driving assembly 4 is then assigned a driver plane 12, which is oriented parallel to the wedge plane 10 and in which the line of force action 13 of the driving force extends. The location of the wedge plane 10 and the location of the driver plane 12 can be gathered from viewing FIGS. 3 and 4 together.

What is essential then is that the pressing drive 8 is configured and arranged such that the wedge plane 10 is located in a manner offset from the driver plane 12 by an offset distance 14. It can be gathered from the illustration in FIG. 3 that here, and preferably, the driver plane 12 is, as a result, free from the pressing drive 8, in particular from the drive wedge 11.

Instead of the drive wedge 11, part of the assembly guide 9 is located in the driver plane 12. Here, and preferably, the assembly guide 9 extends in the driver plane 12. In this case, it is provided in a particularly preferred configuration that the assembly guide 9 has, on both sides of the driving assembly 4, in each case one guide element 9a, 9b located in the driver plane 12. The expression “on both sides” also includes arrangements in which, as here, the guide elements 9a, 9b are integrated into the driving assembly 4 at the sides of the driving assembly 4.

In the exemplary embodiment illustrated and to this extent preferred, the guide elements 9a, 9b have in each case one guide profile connected to the assembly support 3 and a carriage arrangement assigned to the guide profile and connected to the driver assembly 4. Here, and preferably, the guide profiles are cylindrical guide profiles having a circular cross section. The carriage arrangements have in each case two carriages for forming linear dry bearings. Other configurations are conceivable here.

The illustration in FIG. 3 makes it clear that the arrangement of the assembly guide 9 to the side of the driving assembly 4 and in the driver plane 12 leads to a small depth of the driving module, since the assembly guide 9 now makes no contribution at all to increasing the depth of the driving module.

It is apparent in the illustration in FIG. 3 that the depth of the driving module is additionally reduced in that the depth of the driver drive 5 is exceptionally small. Here, and preferably, the driver drive 5 of the driving assembly 4 is configured as an in particular pneumatic piston drive having a driver cylinder 15 and a driver piston 16. The driver cylinder 15 comprises here a housing, the inner surface of which provides the actual cylinder surface. The inner surface of the driver cylinder 15 can be seen in FIG. 1 (in dashed lines) and in FIG. 3.

The depth of the driver drive 5 is now particularly small, since in any case the inner surface of the driver cylinder 15, and thus the outer surface of the driver piston 16, is configured with a cross section that is elongate along a main axis 17. Here, “cross section” means the section extending perpendicularly to the stroke of the piston drive. Only with the cross-sectionally elongate configuration of the inner surface of the driver cylinder 15 can, as illustrated here, the outer surface of the driver cylinder 15 be configured with a correspondingly elongate cross section and thus in an optimized manner in terms of installation space.

As a result of the fact that here, and preferably, the main axis 17 is located in the driver plane 12 (FIG. 3), exclusively the transverse extent of the piston drive makes a contribution to the depth of the driving module. Compared with a circular driver cylinder 15, the depth of the driving module is quite considerably reduced.

In the exemplary embodiment illustrated and to this extent preferred, the driver cylinder 15 is configured with a cross section that is substantially oval. It is also conceivable for the driver cylinder 15 to be configured with a cross section that is elliptical or the like.

Depending on the boundary condition, the length ratios of the driver cylinder 15 and thus of the driver piston 16 can be designed differently. Preferably, the ratio between the longitudinal extent and the transverse extent of the cross-sectionally elongate inner surface of the driver cylinder 15 and thus of the driver piston 16 is between about 1.3 and about 1.9, in particular about 1.6.

The pressing drive 8 is also preferably configured as an in particular pneumatic piston drive, which acts on the drive wedge 11 in a manner substantially perpendicular to the driving direction 6.

Correspondingly, the pressing drive 8 has a cylinder-piston unit 18, which is connected in drive terms to the drive wedge 11.

In order to gain installation space for other components in the driver plane 12, the offset distance is preferably selected such that the pressing drive 8, in particular the drive wedge 11, is located completely outside the driver plane 12. In the exemplary embodiment illustrated and to this extent preferred, the offset distance 14 between the driver plane 12 and the wedge plane 10 is at least about 25%, preferably about 30% of the transverse extent of the outer surface of the driver cylinder 15, wherein it can alternatively or additionally be provided that the drive wedge 11 terminates laterally substantially with the driver cylinder 15. In the exemplary embodiment illustrated, the drive wedge 11 terminates with that side of the driver cylinder 15 that faces the assembly support 3. This can be gathered from the illustration in FIG. 4.

Also of interest in the case of the offset, as proposed, of the pressing drive 8 is the fact that the height of the arrangement of driving assembly 4 and pressing drive 8 can be quite considerably reduced thereby. The reason for this is that, with a suitable design, at least portions of the engagement region 19 between the drive wedge 11 and the driving assembly 4, as seen along the assembly guide 9, are arranged at the same height as the driving assembly 4 and/or as the driver drive 5 and/or as the driver cylinder 15. In other words, the drive wedge 11 can be arranged to the side of the driving assembly 4.

According to the illustration in FIG. 2, it is further the case that at least portions of the engagement region 19 between the drive wedge 11 and the driving assembly 4, as seen along the assembly guide 9, are arranged at the same height as the upper carriage 20 of the carriage arrangement assigned to the guide element 9b.

In the extreme case, it can even be provided that the drive wedge 11 as a whole, in the above sense, is arranged at the same height as the driving assembly 4. The drive wedge 11 would, in the view according to FIG. 1, disappear behind the driving assembly 4 in the completely extended position.

In the above height comparisons, the guide axis, extending vertically in FIG. 1, of the assembly guide 9 forms the benchmark.

Viewing FIGS. 1 and 3 together shows that the assembly support 3 has a substantially plate-like portion 3a, which extends substantially parallel to the driver plane 12 and to which on the one hand the assembly guide 9 is fixed via upper and lower guide supports 21, 22 and on the other hand the pressing drive 8 is fixed. What is advantageous here is the fact that the force flux caused by the pressing drive 8 on the pressing of the driving assembly 4 is closed via the plate-like portion 3a of the assembly support 3. This leads to a particularly stable construction.

The driving module is connected to a portal displacement unit here, and preferably, via a mechanical interface 23 arranged on the upper guide support 21.

The arrangement has a particularly compact configuration in that the drive wedge 11 is arranged between the assembly support 3, here a plane spanned by the plate-like portion 3a of the assembly support 3, and the driver plane 12. This can be gathered most clearly from the illustration in FIG. 4.

The exemplary embodiment illustrated in the drawing further shows a magazining device 24 for the fixing means 1, it being possible for the fixing means 1 to be guided toward a tool head 25 of the driving assembly 4 and brought individually into engagement there with the driver punch 7 by the magazining device. Here, and preferably, the tool head 25 also provides the pressing surface 26, via which the driving assembly 4 comes into engagement with the workpiece 2 during pressing. The magazining device 24 is arranged on the driving assembly 4 such that it moves along with the driving assembly 4 during pressing.

What is essential with respect to the position of the magazining device 24 is now the fact that the magazining device 24 extends in the driver plane 12. Of interest here is that the magazining device 24 makes no contribution to increasing the depth of the driving module 4 as a whole. This is also the case for the separating device 29, provided in a particularly preferred configuration, for the fixing means 1 magazined in strips, the fixing means 1 being supplied strip by strip to the fixing-means support 10 by means of said separating device.

The magazining device 24 has a fixing-means support 27, which leads to the tool head 25 and likewise extends in the driver plane 12. This can be gathered most clearly from viewing FIGS. 1 and 3 together. Here, and preferably, it is further the case that the fixing-means support 27 extends perpendicularly to the driving direction 6.

The magazining device 24 illustrated and to this extent preferred finally comprises a magazine shaft 28, in which strips of fixing means 1 can be magazined one on top of another and at least portions of which preferably extend in the driver plane 12 in order to be able to exploit the offset of the drive wedge 11 out of the driver plane 12 to the fullest extent in terms of installation space.

1. A driving module for driving in particular magazined fixing means, in particular magazined nails, into workpieces, having an assembly support for a driving assembly, wherein the driving assembly has a driver drive which acts with a driving force via a driver punch, which is displaceable in the driving direction, on the fixing means to be driven in each case, wherein the driving assembly as such can be pressed onto the respective workpiece by means of a pressing drive and for this purpose is guided displaceably in the driving direction via an assembly guide on the assembly support, wherein the pressing drive has a drive wedge, which extends in a wedge plane and acts on the driving assembly in order to press the driving assembly onto the respective workpiece, characterized
in that the driving assembly is assigned a driver plane which is oriented parallel to the wedge plane and in which the line of force action of the driving force extends, and in that the pressing drive is configured and arranged such that the wedge plane is located in a manner offset from the driver plane by an offset distance.

2. The driving module as claimed in claim 1, characterized in that the assembly guide extends in the driver plane, preferably in that the assembly guide has, on both sides of the driving assembly, in each case one guide element located in the driver plane, further preferably in that the guide elements have in each case one guide profile connected to the assembly support and a carriage arrangement assigned to the guide profile and connected to the driving assembly.

3. The driving module as claimed in claim 1, characterized in that the driver drive of the driving assembly is configured as an in particular pneumatic piston drive having a driver cylinder and a driver piston, and in that the inner surface of the driver cylinder is configured with a cross section that is elongate along a main axis, in particular elliptical.

4. The driving module as claimed in claim 3, characterized in that the main axis of the cross-sectionally elongate inner surface of the driver cylinder is located in the driver plane.

5. The driving module as claimed in claim 3, characterized in that the ratio between the longitudinal extent and the transverse extent of the cross-sectionally elongate inner surface of the driver cylinder is between about 1.3 and about 1.9, in particular about 1.6.

6. The driving module as claimed in claim 1, characterized in that the pressing drive is configured as an in particular pneumatic piston drive, which acts on the drive wedge in a manner substantially perpendicular to the driving direction.

7. The driving module as claimed in claim 1, characterized in that the offset distance between the driver plane and the wedge plane is at least about 25%, preferably about 30% of the transverse extent of the outer surface of the driver cylinder, and/or in that the drive wedge terminates laterally substantially with the driver cylinder.

8. The driving module as claimed in claim 1, characterized in that at least portions of the engagement region between the drive wedge and the driving assembly, as seen along the assembly guide, are arranged at the same height as the driving assembly and/or as the driver drive and/or as the driver cylinder.

9. The driving module as claimed in claim 1, characterized in that the assembly support has a substantially plate-like portion, which extends substantially parallel to the driver plane and to which the assembly guide and the pressing drive are fixed.

10. The driving module as claimed in claim 1, characterized in that the drive wedge is arranged between the assembly support, in particular a plane spanned by the plate-like portion of the assembly support, and the driver plane.

11. The driving module as claimed claim 1, characterized in that a magazining device for the fixing means is provided, it being possible for the fixing means to be guided toward the driving assembly and brought individually into engagement there with the driver punch by the magazining device, and in that the magazining device has a fixing-means support, which leads to a tool head and extends in the driver plane, preferably in that the fixing-means support extends perpendicularly to the driving direction.

12. The driving module as claimed in claim 11, characterized in that the magazining device comprises a magazine shaft, in which strips of fixing means can be magazined one on top of another, and in that at least portions of the magazine shaft extend in the driver plane.
